(19) United States
(12) Patent Application Publication
(10) Pub. No.: US 2026/0133982 A1
(43) Pub. Date: May 14, 2026

(54) SYSTEMS AND METHODS FOR MULTI-STAGE SEARCH AND DISTANCE APPROXIMATION IN HIGH-DIMENSIONAL FEATURE VECTOR SPACES

(71) Applicant: Macronix International Co., Ltd., Hsinchu (TW)

(72) Inventors: Han-Wen Hu, Zhubei (TW); Bo-Rong Lin, Taichung (TW); Huai-Mu Wang, New Taipei (TW)

(21) Appl. No.: 19/076,667

(22) Filed: Mar. 11, 2025

Related U.S. Application Data
(60) Provisional application No. 63/718,749, filed on Nov. 11, 2024.

(51) Int. Cl. G06F 16/2458; G06F 16/22; G06F 16/28

(52) U.S. Cl. CPC G06F 16/2462; G06F 16/2237; G06F 16/285

(57) ABSTRACT

Systems, devices, methods, and circuits are provided for retrieving and searching information by computing Euclidean distances between a query vector and feature vectors within a dataset. In one aspect, an example method includes receiving a request indicating a query vector. A plurality of clusters of feature vectors are obtained. A plurality of distances between the query vector and centroid vectors of the plurality of clusters are determined. One or more clusters are selected from the plurality of clusters based on the plurality of distances between the query vector and the centroid vectors of the plurality of clusters. For each feature vector of the selected one or more clusters, a distance between the query vector and the feature vector is determined. One or more feature vectors are selected from the one or more clusters based on distances between the query vector and feature vectors of the one or more clusters.

### BACKGROUND

Searching in databases involves retrieving specific information from large collections of structured data by using queries. These queries define criteria to filter and extract relevant records quickly and accurately. Depending on the requirements, searches can vary from simple exact matches to more advanced queries, such as range searches, pattern matching, or full-text searches. Effective database search ensures that users can access the needed data efficiently, supporting various analytical and operational tasks.

### SUMMARY

The present disclosure describes methods, devices, systems, and techniques for efficiently retrieving and searching information by computing Euclidean distances between a query vector and feature vectors within a dataset, facilitating accurate similarity-based searches and data retrieval.

One aspect of the present disclosure features a semiconductor device. The semiconductor device includes a memory cell array configured to store data in memory cells and a circuitry coupled to the memory cell array. The circuitry is configured to execute operations in the memory cell array. The operations executed by the circuitry includes: receiving a request indicating a query vector; obtaining a plurality of clusters of feature vectors, wherein each cluster of the plurality of clusters is associated with a respective centroid vector; determining a plurality of distances between the query vector and centroid vectors of the plurality of clusters; selecting, from the plurality of clusters, one or more clusters based on the plurality of distances between the query vector and the centroid vectors of the plurality of clusters; for each feature vector of the one or more clusters, determining a distance between the query vector and the feature vector; and selecting one or more feature vectors from the one or more clusters based on distances between the query vector and feature vectors of the one or more clusters.

In some implementations, the distance between the query vector and the feature vector includes a Euclidean distance.

In some implementations, determining the distance between the query vector and the feature vector includes: determining a distance between the feature vector and a centroid vector of a cluster to which the feature vector belongs; determining a distance between the query vector and the centroid vector of the cluster to which the feature vector belongs; determining a dot product of the query vector and the feature vector; and determining the distance between the query vector and the feature vector based on the distance between the feature vector and the centroid vector, the distance between the query vector and the centroid vector, and the dot product.

In some implementations, determining the distance between the feature vector and the centroid vector of the cluster to which the feature vector belongs includes: determining the distance between the feature vector and the centroid vector of the cluster using a look-up table associated with the cluster, wherein the look-up table indicates a mapping relationship between feature vectors of the cluster and distances between the feature vectors and the centroid vector of the cluster.

In some implementations, determining the distance between the feature vector and the centroid vector of the cluster to which the feature vector belongs includes: determining a scale level of the feature vector in the cluster to which the feature vector belongs; determining a first value indicating an interval between adjacent scale levels of the cluster; determining a second value indicating a magnitude of a smallest scale level of the cluster; and determining the distance between the feature vector and the centroid vector of the cluster based on the scale level of the feature vector, the first value, and the second value.

In some implementations, determining the scale level of the feature vector in the cluster to which the feature vector belongs includes: determining the scale level of the feature vector in the cluster based on closeness of the feature vector to adjacent scale levels in the cluster.

In some implementations, selecting the one or more feature vectors from the one or more clusters based on the distances between the query vector and the feature vectors of the one or more clusters includes: selecting a set of feature vectors from the one or more clusters based on a distance threshold, wherein a distance between each feature vector of the set of feature vectors and the query vector is less than the distance threshold; and selecting, from the set of feature vectors, the one or more feature vectors that have one or more shortest distances to the query vector.

In some implementations, the selecting, from the plurality of clusters, the one or more clusters based on the plurality of distances between the query vector and the centroid vectors of the plurality of clusters includes: selecting, from the plurality of clusters, the one or more clusters associated with one or more centroid vectors that have one or more shortest distances to the query vector.

Another aspect of the present disclosure features a system. The system includes a semiconductor device and a controller coupled to the semiconductor device and configured to control the semiconductor device. The semiconductor device includes a memory cell array configured to store data in memory cells and a circuitry coupled to the memory cell array. The circuitry is configured to execute operations in the memory cell array. The operations executed by the circuitry includes: receiving a request indicating a query vector; obtaining a plurality of clusters of feature vectors, wherein each cluster of the plurality of clusters is associated with a respective centroid vector; determining a plurality of distances between the query vector and centroid vectors of the plurality of clusters; selecting, from the plurality of clusters, one or more clusters based on the plurality of distances between the query vector and the centroid vectors of the plurality of clusters; for each feature vector of the one or more clusters, determining a distance between the query vector and the feature vector; and selecting one or more feature vectors from the one or more clusters based on distances between the query vector and feature vectors of the one or more clusters.

In some implementations, the distance between the query vector and the feature vector includes a Euclidean distance.

In some implementations, determining the distance between the query vector and the feature vector includes: determining a distance between the feature vector and a centroid vector of a cluster to which the feature vector belongs; determining a distance between the query vector and the centroid vector of the cluster to which the feature vector belongs; determining a dot product of the query vector and the feature vector; and determining the distance between the query vector and the feature vector based on the distance between the feature vector and the centroid vector, the distance between the query vector and the centroid vector, and the dot product.

In some implementations, determining the distance between the feature vector and the centroid vector of the cluster to which the feature vector belongs includes: determining the distance between the feature vector and the centroid vector of the cluster using a look-up table associated with the cluster, wherein the look-up table indicates a mapping relationship between feature vectors of the cluster and distances between the feature vectors and the centroid vector of the cluster.

In some implementations, determining the distance between the feature vector and the centroid vector of the cluster to which the feature vector belongs includes: determining a scale level of the feature vector in the cluster to which the feature vector belongs; determining a first value indicating an interval between adjacent scale levels of the cluster; determining a second value indicating a magnitude of a smallest scale level of the cluster; and determining the distance between the feature vector and the centroid vector of the cluster based on the scale level of the feature vector, the first value, and the second value.

In some implementations, determining the scale level of the feature vector in the cluster to which the feature vector belongs includes: determining the scale level of the feature vector in the cluster based on closeness of the feature vector to adjacent scale levels in the cluster.

In some implementations, selecting the one or more feature vectors from the one or more clusters based on the distances between the query vector and the feature vectors of the one or more clusters includes: selecting a set of feature vectors from the one or more clusters based on a distance threshold, wherein a distance between each feature vector of the set of feature vectors and the query vector is less than the distance threshold; and selecting, from the set of feature vectors, the one or more feature vectors that have one or more shortest distances to the query vector.

In some implementations, the selecting, from the plurality of clusters, the one or more clusters based on the plurality of distances between the query vector and the centroid vectors of the plurality of clusters includes: selecting, from the plurality of clusters, the one or more clusters associated with one or more centroid vectors that have one or more shortest distances to the query vector.

A further aspect of the present disclosure features a method, including: receiving a request indicating a query vector; obtaining a plurality of clusters of feature vectors, wherein each cluster of the plurality of clusters is associated with a respective centroid vector; determining a plurality of distances between the query vector and centroid vectors of the plurality of clusters; selecting, from the plurality of clusters, one or more clusters based on the plurality of distances between the query vector and the centroid vectors of the plurality of clusters; for each feature vector of the one or more clusters, determining a distance between the query vector and the feature vector; and selecting one or more feature vectors from the one or more clusters based on distances between the query vector and feature vectors of the one or more clusters.

In some implementations, the distance between the query vector and the feature vector includes a Euclidean distance.

In some implementations, determining the distance between the query vector and the feature vector includes: determining a distance between the feature vector and a centroid vector of a cluster to which the feature vector belongs; determining a distance between the query vector and the centroid vector of the cluster to which the feature vector belongs; determining a dot product of the query vector and the feature vector; and determining the distance between the query vector and the feature vector based on the distance between the feature vector and the centroid vector, the distance between the query vector and the centroid vector, and the dot product.

In some implementations, determining the distance between the feature vector and the centroid vector of the cluster to which the feature vector belongs includes: determining the distance between the feature vector and the centroid vector of the cluster using a look-up table associated with the cluster, wherein the look-up table indicates a mapping relationship between feature vectors of the cluster and distances between the feature vectors and the centroid vector of the cluster.

Implementations of the above techniques include methods, systems, circuits, computer program products and computer-readable media. In one example, a method can include the above-described actions. In another example, one such computer program product is suitably embodied in a non-transitory machine-readable medium that stores instructions executable by one or more processors. The instructions are configured to cause the one or more processors to perform the above-described actions. One such computer-readable medium stores instructions that, when executed by one or more processors, are configured to cause the one or more processors to perform the above-described actions.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1A is diagram illustrating an example of a system, according to one or more implementations of the present disclosure.

FIG. 1B is a diagram illustrating another example of a system including a controller and a memory device, according to one or more implementations of the present disclosure.

FIG. 1C is a diagram illustrating another example of a system, according to one or more implementations of the present disclosure.

FIG. 2 is a diagram illustrating an example of a memory device, according to one or more implementations of the present disclosure.

FIG. 3 is a flow chart illustrating an example method for determining a distance between a query vector and a feature vector, according to one or more implementations of the present disclosure.

FIG. 4 is a flow chart illustrating an example method for structuring search data, according to one or more implementations of the present disclosure.

FIG. 5 is a diagram illustrating an example method for clustering feature vectors, according to one or more implementations of the present disclosure.

FIG. 6 is a diagram illustrating an example method for computing an approximation to a squared vector length of a feature vector, according to one or more implementations of the present disclosure.

FIG. 7 is a diagram illustrating an example search method, according to one or more implementations of the present disclosure.

FIG. 8 is a flow chart illustrating an example search method, according to one or more implementations of the present disclosure.

Like reference numbers and designations in the various drawings indicate like elements. It is also to be understood that the various exemplary implementations shown in the figures are merely illustrative representations and are not necessarily drawn to scale.

### DETAILED DESCRIPTION

In certain applications, such as content search or classification tasks, input data can be represented as numerical vectors that capture various attributes. A host device processes these vectors to identify relevant results or matches. Traditional methods often involve transferring large amounts of data between different processing units and memory hierarchies, leading to bottlenecks that reduce processing efficiency. Even with optimizations that reduce data size, these approaches frequently encounter limitations due to low data reuse and the restricted parallel throughput of conventional processors.

For large-scale datasets, directly computing across billions of vector entries presents computational challenges due to the immense processing requirements. The need for frequent data transfers between memory and processing units exacerbates inefficiencies, leading to increased delays and resource utilization. These challenges are compounded by the complexity of operations required, which demand high computational throughput and efficient data handling across large datasets. Without an effective solution, meeting the performance requirements of large-scale data processing remains a critical bottleneck.

The increasing demand for processing large-scale, complex data has highlighted the need for efficient computing systems capable of handling high-dimensional vector representations. A host device may supply vectorized data to a memory device and instruct the memory device to execute specific operations. By performing these operations locally within the memory, the time required to return results to the host device can be reduced, improving overall computing efficiency. However, memory bottlenecks can arise due to frequent data transfers between the host device and the memory device, which limit the system's ability to fully exploit parallel processing capabilities.

Implementations of the present disclosure provides a multi-stage search approach, which can reduce computational load and mitigate memory bottlenecks in a search process. The multi-stage search organizes vectorized data into clusters, with each cluster associated with a centroid vector. During processing, a subset of clusters is selected based on their proximity to the query vector, decreasing the amount of computation required. Within the selected clusters, the similarity between the query vector and feature vectors can be determined by computing a distance measure, such as the Euclidean distance. However, direct computation of the Euclidean distance involves complex operations, such as vector normalization, which can impose a heavy computational burden on the memory.

To alleviate this issue, an approximation of the Euclidean distance can be used, based on a linear function that simplifies the required computations. In some implementations, certain terms of the distance calculation can be pre-computed during an offline phase, e.g., by a host processor, and stored locally in the memory. During the online phase, only a portion of the computation needs to be performed in memory, reducing the real-time computational workload. This division of computation into offline and online phases allows for more efficient use of memory resources, further reducing processing delays and energy consumption.

By adjusting the handling of data between memory and processing units, the techniques implemented herein not only improve performance for large-scale data operations but also support complex functions that can be decomposed into offline and online computational components. In some cases, certain non-linear functions that are too complex for direct in-memory computation can be transformed into simpler linear operations by breaking them into two parts. Pre-computing and storing offline results in memory allows the remaining online in-memory computations to be executed efficiently with reduced overhead, thus enabling support for a broader range of complex operations.

### Example Systems and Devices

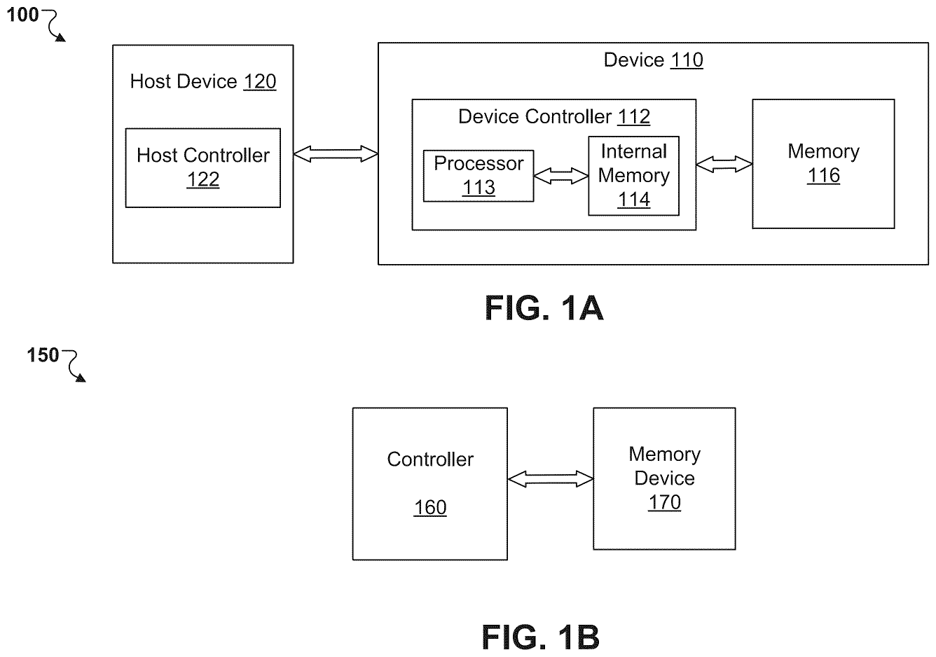

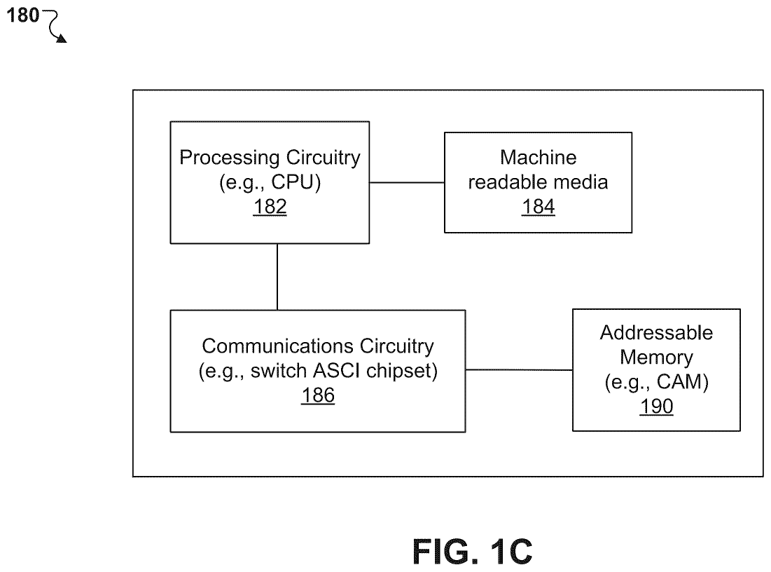

FIG. 1A illustrates an example of a system 100. The system 100 includes a device 110 and a host device 120. The device 110 includes a device controller 112 and a memory 116. The device controller 112 includes a processor 113 and an internal memory 114. In some implementations, the device 110 includes a plurality of memories 116 that are coupled to the device controller 112. The memory 116 includes a plurality of blocks. The memory 116 can be a two-dimensional (2D) memory including 2D memory blocks. The memory 116 can also be a three-dimensional (3D) memory including 3D memory blocks.

The host device 120 includes a host controller 122 that can include at least one processor and at least one memory coupled to the at least one processor and storing programming instructions for execution by the at least one processor to perform one or more corresponding operations.

In some implementations, the device 110 is a storage device. For example, the device 110 can be an embedded multimedia card (eMMC), a secure digital (SD) card, a solid-state drive (SSD), or some other suitable storage. In some implementations, the device 110 is a smart watch, a digital camera or a media player. In some implementations, the device 110 is a client device that is coupled to a host device 120. For example, the device 110 is an SD card in a digital camera or a media player that is the host device 120.

The device controller 112 is a general-purpose microprocessor, or an application-specific microcontroller. In some implementations, the device controller 112 is a memory controller for the device 110. The following sections describe the various techniques based on implementations in which the device controller 112 is a memory controller. However, the techniques described in the following sections are also applicable in implementations in which the device controller 112 is another type of controller that is different from a memory controller.

The processor 113 is configured to execute instructions and process data. The instructions include firmware instructions and/or other program instructions that are stored as firmware code and/or other program code, respectively, in the secondary memory. The data includes program data corresponding to the firmware and/or other programs executed by the processor, among other suitable data. In some implementations, the processor 113 is a general-purpose microprocessor, or an application-specific microcontroller.

The processor 113 accesses instructions and data from the internal memory 114. In some implementations, the internal memory 114 is a Static Random Access Memory (SRAM) or a Dynamic Random Access Memory (DRAM). For example, in some implementations, when the device 110 is an eMMC, an SD card or a smart watch, the internal memory 114 is an SRAM. In some implementations, when the device 110 is a digital camera or a media player, the internal memory 114 is DRAM.

In some implementations, the internal memory is a cache memory that is included in the device controller 112, as shown in FIG. 1A. The internal memory 114 stores instruction codes, which correspond to the instructions executed by the processor 113, and/or the data that are requested by the processor 113 during runtime. The device controller 112 transfers the instruction code and/or the data from the memory 116 to the internal memory 114.

In some implementations, the memory 116 is a non-volatile memory that is configured for long-term storage of instructions and/or data, e.g., an NAND or NOR flash memory device, or some other suitable non-volatile memory device. The memory 116 can include one or more memory chips. In implementations where the memory 116 is an NAND flash memory, the device 110 is a flash memory device, e.g., a flash memory card, and the device controller 112 is an NAND flash controller. For example, in some implementations, when the device 110 is an eMMC or an SD card, the memory 116 is an NAND flash memory; in some implementations, when the device 110 is a digital camera, the memory 116 is an SD card; and in some implementations, when the device 110 is a media player, the memory 116 is a hard disk. In some implementations where the memory 116 is an NOR flash memory, the device 110 can optionally include the device controller 112. In some cases, the device 110 can include no device controller and the memory 116 can directly communicate with the host device 120.

FIG. 1B is a schematic diagram illustrating another example of a system 150 including a controller 160 and a memory device 170, according to one or more implementations of the present disclosure. The controller 160 is coupled to the memory device 170 via an electrical connection, e.g., an electrical wire, pin or bus, or a wireless connection, and communicates, e.g., directly, with the memory device 170. The controller 160 can be the host controller 122 of FIG. 1A or the device controller 112 of FIG. 1A.

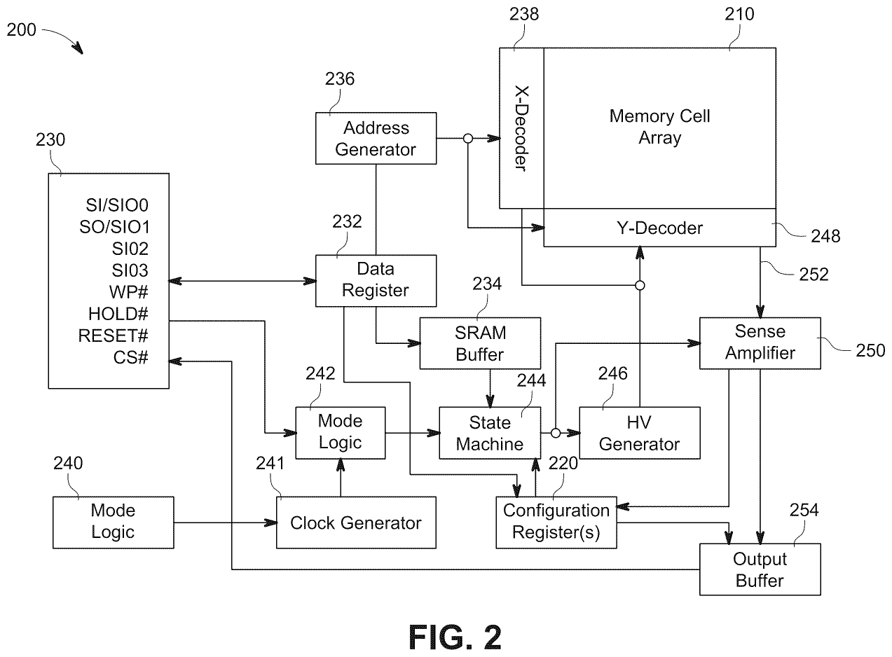

FIG. 1C is a schematic diagram illustrating another example of a system 180 including an addressable memory 190, according to one or more implementations of the present disclosure. The addressable memory 190 can be the memory 116 of FIG. 1A or the memory device 170 of FIG. 1B, or any memory devices described with respect to FIGS. 2-10 (e.g., memory device 200 of FIG. 2). The system 180 can include any number of different computing devices that are suitable for implementing content addressable memory, including but not limited to servers, network switches, gateway devices, among other devices.

In some implementations, the system 180 includes a network device (e.g., switch, gateway, etc.). As shown in FIG. 1C, the system 180 includes the addressable memory 190, processing circuitry 182, machine readable media 184, and communications circuitry 186. The processing circuitry 182 is configured to supply a control signal or a command through the communications circuitry 186 to the addressable memory 190. The processing circuitry 182 can be any circuitry capable of executing non transitory machine-readable instructions, such as a central processing unit (CPU), a microprocessor, a microcontroller, a digital signal processor (DSP), etc. The machine-readable media 184 can be any non-transitory machine-readable medium, including but not limited to volatile storage media (e.g., dynamic RAM (DRAM), SRAM, etc.) and/or non-volatile storage media (e.g., PROM, EPROM, EEPROM, NVRAM, hard drives, etc.). The machine-readable media 184 can store machine-readable instructions that, when executed by processing circuitry 182, cause the system 180 to perform one or more operations, such as programming, searching, and reading operations.

The communications circuitry 186 can include transceiver circuitry for receiving input data communications and transmitting output data communications. In various implementations, the communications circuitry 186 can include a network interface card (NIC) including a plurality of different communication ports in compliance with a plurality of different communication standards. In various implementations, the communications circuitry 186 can include a plurality of communications ports, which can serve to connect multiple other electronic devices to one another via the system 180. In some examples, the communications circuitry 186 can be a network router, switch, gateway, or other routing device for a network, and may perform various traffic control tasks such as routing, switching, etc. The communications circuitry 186 can include an application-specific integrated circuit (ASIC), a field-programmable gate array (FPGA), an application-specific instruction set processor (ASIP), or the like, that is configured to perform certain operations. For example, the communications circuitry 186 can be a switch ASIC chipset.

In some implementations, the communications circuitry 186 can determine which communication port to forward the received communication to based on the destination address identified in a received data packet. The system 180 can utilize the addressable memory 190 to identify the communications port to which to send a received data packet by searching the addressable memory 190 using a destination address in the received data packet. For example, the system 180 can be connected in a network to a plurality of other devices, each of the other devices having a unique address (e.g., a unique IP address). The system 180 can store this information in the addressable memory 190 such that the location of the stored device address within the addressable memory 190 corresponds to a specific communications port through which the system 180 and a particular other device are connected. Each stored word in the addressable memory 190 can correspond to a different communications port. In various implementations, when a new device is connected to the system 180, the unique address for the newly-added device can be written to a data word of the addressable memory 190. Upon receipt of a new data communication (packet), a destination address included within the received data packet is extracted and sent to the addressable memory 190 directly from the communications circuitry 186 in some implementations, while in other implementations the destination address may be provided indirectly through the processing circuitry 182.

If a match is identified, the addressable memory 190 returns a memory address (e.g., a location within RAM) to the communications circuitry 186, either directly or through the processing circuitry 182. Because each data word of the addressable memory 190 corresponds to a particular communications port of the communications circuitry 186, the memory address of the stored data word associated storage block can be understood by communications circuitry to identify a particular communications port, and therefore the communications circuitry 186 can determine which communications port to forward the communication packet based on the output address of the addressable memory 190.

### Example Memory Devices

FIG. 2 is a schematic diagram illustrating an example of a memory device 200, according to one or more implementations of the present disclosure. The memory device 200 can be the memory 116 of FIG. 1A, the memory device 170 of FIG. 1B, or the addressable memory 190 of FIG. 1C.

As illustrated in FIG. 2, the memory device 200 includes a number of components that can be integrated onto a board, e.g., a Si-based carrier board, and be packaged. The memory device 200 can have a memory cell array 210 that can include a number of memory cells. The memory cells can be coupled in series to a number of row word lines and a number of column bit lines.

Each memory cell can include at least one memory transistor configured as a storage element to store data. The memory transistor can include a silicon-oxide-nitride-oxide-silicon (SONOS) transistor, a floating gate transistor, a nitride read only memory (NROM) transistor, or any suitable non-volatile memory MOS device that can store charges.

The memory device 200 can include an X-decoder (or row decoder) 238 and optionally a Y-decoder (or column decoder) 248. Each memory cell can be coupled to the X-decoder 238 via a respective word line and coupled to the Y-decoder 248 via a respective bit line. Accordingly, each memory cell can be selected by the X-decoder 238 and the Y-decoder 248 for read or write operations through the respective word line and the respective bit line.

The memory device 200 can include a memory interface (input/ouput—I/O) 230 having multiple pins configured to be coupled to an external device, e.g., the device controller 112 and/or the host device 120 of FIG. 1A or the controller 160 of FIG. 1B. The memory interface 230 can be a Serial Peripheral Interface (SPI) or any other suitable interface.

In some implementations, the pins in the memory interface 230 can include SI/SIO0 for serial data input/serial data input & output, SO/SIO1 for serial data output/serial data input &output, SIO2 for serial data input or output, SIO3 for serial data input or output, RESET # for hardware reset pin active low, CS # for chip select. The memory interface 230 can also include one or more other pins, e.g., WP # for write protection active low, and/or Hold # for a holding signal input.

The memory device 200 can include a data register 232, an SRAM buffer 234, an address generator 236, a synchronous clock (SCLK) input 240, a clock generator 241, a mode logic 242, a state machine 244, and a high voltage (HV) generator 246. The SCLK input 240 can be configured to receive a synchronous clock input and the clock generator 241 can be configured to generate a clock signal for the memory device 200 based on the synchronous clock input. The mode logic 242 can be configured to determine whether there is a read or write operation and provide a result of the determination to the state machine 244.

The memory device 200 can also include a sense amplifier 250 that can be optionally connected to the Y-decoder 248 by a data line 252 and an output buffer 254 for buffering an output signal from the sense amplifier 250 to the memory interface 230. The sense amplifier 250 can be part of read circuitry that is used when data is read from the memory device 200. The sense amplifier 250 can be configured to sense low power signals from a bit line that represents a data bit (1 or 0) stored in a memory cell and to amplify small voltage swings to recognizable logic levels so the data can be interpreted properly. The sense amplifier 250 can also communicate with the state machine 244, e.g., bidirectionally.

A controller, e.g., the host controller 122 or the device controller 112 of FIG. 1A or the controller 160 of FIG. 1B, can generate commands, such as read commands and/or write commands that can be executed respectively to read data from and/or write data to the memory device 200. Data being written to or read from the memory the array 210 can be communicated or transmitted between the memory device 200 and the controller and/or other components via a data bus (e.g., a system bus), which can be a multi-bit bus.

In some examples, during a read operation, the memory device 200 receives a read command from the controller through the memory interface 230. The state machine 244 can provide control signals to the HV generator 246 and the sense amplifier 250. The sense amplifier 250 can also send information, e.g., sensed logic levels of data, back to the state machine 244. The HV generator 246 can provide a voltage to the X-decoder 238 and the Y-decoder 248 for selecting a memory cell. The sense amplifier 250 can sense a small power (voltage or current) signal from a bit line that represents a data bit (1 or 0) stored in the selected memory cell and amplify the small power signal swing to recognizable logic levels so the data bit can be interpreted properly by logic outside the memory device 200. The output buffer 254 can receive the amplified voltage from the sense amplifier 250 and output the amplified power signal to the logic outside the memory device 200 through the memory interface 230.

In some examples, during a write operation, the memory device 200 receives a write command from the controller. The data register 232 can register input data from the memory interface 230, and the address generator 236 can generate corresponding physical addresses to store the input data in specified memory cells of the memory cell array 210. The address generator 236 can be connected to the X-decoder 238 and Y-decoder 248 that are controlled to select the specified memory cells through corresponding word lines and bit lines. The SRAM buffer 234 can retain the input data from the data register 232 in its memory as long as power is being supplied. The state machine 244 can process a write signal from the SRAM buffer 234 and provide a control signal to the HV generator 246 that can generate a write voltage and provide the write voltage to the X-decoder 238 and the Y-decoder 248. The Y-decoder 248 can be configured to output the write voltage to the bit lines for storing the input data in the specified memory cells. The state machine 244 can also provide information, e.g., state data, to the SRAM buffer 234. The SRAM buffer 234 can communicate with the output buffer 254, e.g., sending information or data out to the output buffer 254.

As illustrated in FIG. 2, the memory device 200 can include one or more configuration registers 220. The configuration register(s) 220 can be coupled to one or more components in the memory device 200, e.g., the data register 232, the state machine 244, the sense amplifier 250, and/or the output buffer 254. In some implementations, the configuration register(s) 220 can be configurable through a command input from the controller, e.g., through the memory interface 230 and the data register 232. In some implementations, the configuration register(s) 220 can be pre-defined in the memory cell array 210 or inside circuitry of the memory device 200, e.g., through the sense amplifier 250. The configuration register(s) 220 can store and provide information of search length, search depth, and/or search data string to the state machine 244 for generating corresponding control signals.

A search operation can include one or more search sessions. Each search session can include one or more search runs. Different search sessions can have different search data or a same search data. A configuration register can include a search length register (SLR), a search depth register (SDR), or a search data register (DR). The SLR is configured to define a search length of a search run, e.g., 34 bits, 68 bits, or 136 bits. The SDR is configured to define a search depth or a search range of the search session or operation, e.g., 1 KB (kilobyte), 2 KB, or 4 KB. The DR is configured to store a search data (e.g., a data string for search) used to compare in search. The memory device 200 can include multiple search data registers to store multiple sets of search data for multiple search sessions together. The configuration register, e.g., SLR, SDR, and/or DR, can be configurable by option codes (OPs).

In some cases, a search length and a search depth for a search operation can be specified in the option code from the controller. In some cases, a search length and a search depth for a search operation can be predefined in the memory device 200. For example, the search length can be predetermined to be 34 bits, and the search depth for each search session can be predetermined to be 1 KB. The search operation can include multiple search sessions.

In some cases, search data and a search starting address are sent together with a command for a search operation to the memory device 200, and an option code can specify which search data register to store the search data. In some cases, multiple sets of search data can be sent, separately or together, before sending a command for a search operation to the memory device 200. The multiple sets of search data can be stored in respective search data registers specified by respective option codes. Then, the command for the search operation can be sent with a search starting address and an option code specifying which search data register among the multiple search data registers for which search session among multiple search sessions in the search operation.

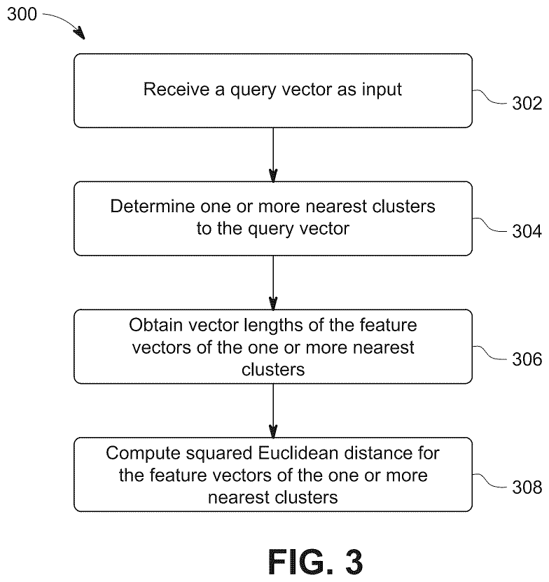

FIG. 3 is a flow chart illustrating an example method 300 for determining a distance between a query vector and a feature vector, according to one or more implementations. The method 300 can be performed by a memory device, e.g., the memory 116 of FIG. 1A, the memory device 170 of FIG. 1B, the addressable memory 190 of FIG. 1C, or the memory device 200 of FIG. 2, or the memory device and a controller, e.g., the host controller 122 of FIG. 1A, or the controller 160 of FIG. 1B, or the processing circuitry 182 and/or the communications circuitry 186 of FIG. 1C.

The method 300 is described in the context of a computing task for determining a Euclidean distance between an input query vector and each of a plurality of feature vectors so as to find one or more feature vectors that have the smallest Euclidean distances to the input query vector. For illustrative purposes only, the description of method 300 includes the computation of Euclidean distance. It is noted that the method 300 can be also applied for other computation, e.g., determining a similarity between two vectors such as cosine similarity or dot product distance. By finding the feature vectors with the smallest Euclidean distances to the input query, the method 300 can be practically adopted in a query-based search (e.g., search for content with features closest to the features included in the query), brute force search (e.g., search for a specified target by exhausting all possibilities), and behavior-based content recommendation (e.g., provide a recommendation that matches a user's interest based on the user's or other users' past behavior). With the adoption of the method 300 or the like in those applications, network techniques such as search engine optimization, route planning, metadata management, and network security can have improved efficiency, accuracy, and data integrity, and/or business and consumer experience in industries such as e-commerce, social media, and/or supply chain management can also be similarly improved.

A query vector is received (302). In some implementations, a query vector is a vector that represents the attributes of a user-provided query. The query vector can encode relevant characteristics of the query in numeric format. For example, when a user queries an application for a movie, the query vector may encode features such as the desired movie length, preferred language, and genre. These encoded attributes are represented as numerical values in the query vector, facilitating computational tasks such as similarity search or matching operations.

In some implementations, the query vector is compared with feature vectors stored in a database or other repositories. In some implementations, a feature vector represents the attributes or characteristics of an object, entity, or input in numeric form. In some examples, a feature vector can comprise a set of numerical values, each corresponding to a specific feature or property of the object. For example, in a query-based search for a movie, a feature vector can encode attributes such as length, language, and genre as distinct numerical values, forming a structured, multi-dimensional representation that can be processed efficiently by a computing system.

Within a database, each feature vector can serve as a compact and standardized representation of an individual data entry. This structure can enable efficient computational operations, including searching, sorting, and matching. In a query-based search system, the database can store a plurality of feature vectors, with each vector uniquely representing a data item. The use of feature vectors transforms complex datasets into a structured format suitable for computational algorithms. By encoding each data entry as a feature vector, the system facilitates high-performance similarity searches by comparing the query vector with stored feature vectors to identify the most relevant matches.

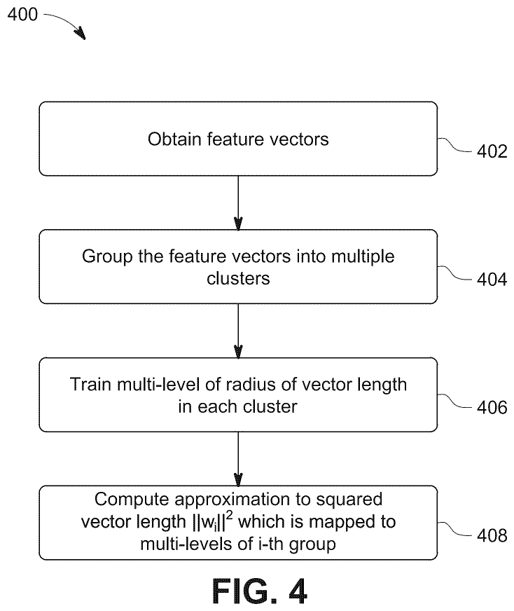

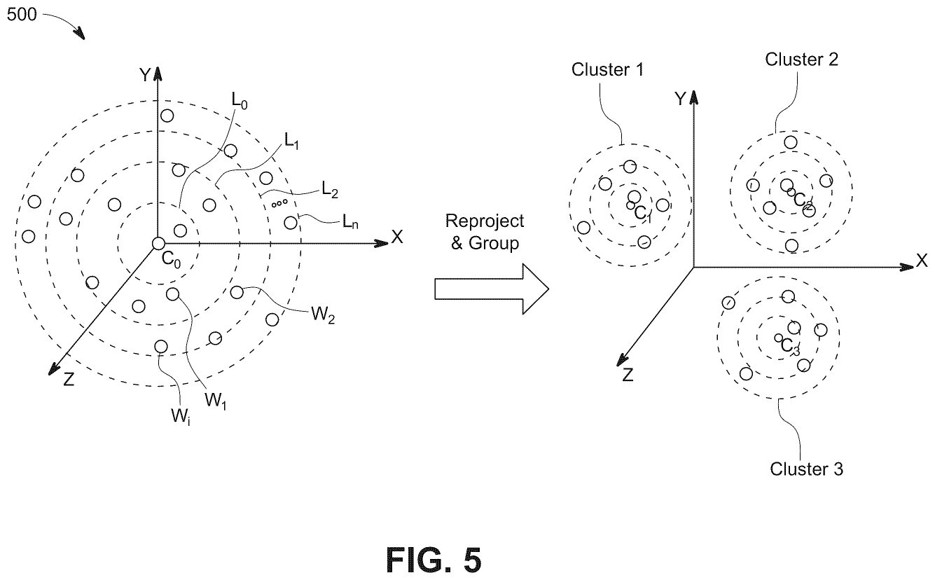

In some implementations, feature vectors in the database can be grouped into clusters. Each cluster includes a subset of the features vectors in the database, and each cluster can be associated with a centroid, such as a centroid vector or a centroid point. Examples of the clustering methods are described with greater detail below with reference to FIGS. 4-5.

Upon receiving the query vector, one or more nearest clusters to the query vector are determined (304). In some implementations, the proximity of the clusters is determined by calculating the distances between the query vector and the centroid vectors representing each cluster. In some examples, the nearest clusters can be selected by identifying the clusters with the top-n (e.g. top-256) smallest distances among the computed distances.

In some implementations, after the nearest clusters are selected, a similarity between the query vector and each feature vector within these clusters is determined. In some implementations, the similarity is determined by computing the Euclidean distance. In some cases, the squared Euclidean distance is used instead of the Euclidean distance to enhance computational efficiency and numerical stability. Computation of the Euclidean distance involves computing the square root of the sum of squared differences between two vectors. Since computing a square root is computationally expensive, especially when processing large datasets or high-dimensional vectors, using the squared Euclidean distance can avoid this costly operation, thereby improving overall performance. Furthermore, when the objective is to compare relative distances or rankings between data points, the squared Euclidean distance can be sufficient. The square root function is monotonic, meaning that it preserves the order of values. As a result, comparing squared Euclidean distances can yield the same ranking as comparing actual Euclidean distances, generating equivalent outcomes while reducing computational overhead.

In some applications, using squared values can also enhance numerical stability by avoiding potential precision issues associated with computing square roots of very small or very large numbers. Therefore, by substituting the squared Euclidean distance for the Euclidean distance, systems implemented in the present disclosure can achieve greater computational efficiency without compromising the accuracy of relative distance comparisons.

Vector lengths of the feature vectors of the one or more nearest clusters are obtained (306). In some implementations, a squared Euclidean distance can be computed using the following formula: d²=∥x−wᵢ∥²=∥x∥²+∥wᵢ∥²−2×·wᵢ, where d² represents squared Euclidean distance, x represents an input query vector, wᵢ represents a feature vector. Therefore, ∥x∥ is computed as a vector length of the query vector x, and ∥wᵢ∥ is computed as a vector length of the feature vector wᵢ, and x·wᵢ is computed as a dot product of the query vector x and the feature vector wᵢ. Therefore, computation of the squared Euclidean distance involves computation of a first term ∥x∥², a second term ∥wᵢ∥², and a third term 2x·wᵢ.

Computation of the first term ∥x∥² and the second term ∥wᵢ∥² can be computationally expensive for the memory and thus can impose a significant computational load on the memory. To mitigate the computational burden on the memory, the first term ∥x∥² can be computed in an online computing phase by a host processor, while the second term ∥wᵢ∥² can be computed in an offline phase, prior to receiving the query vector. The third term 2x·wᵢ can be computed directly in memory after receiving the query vector. This approach can reduce the overall computational burden on the memory, improving processing efficiency.

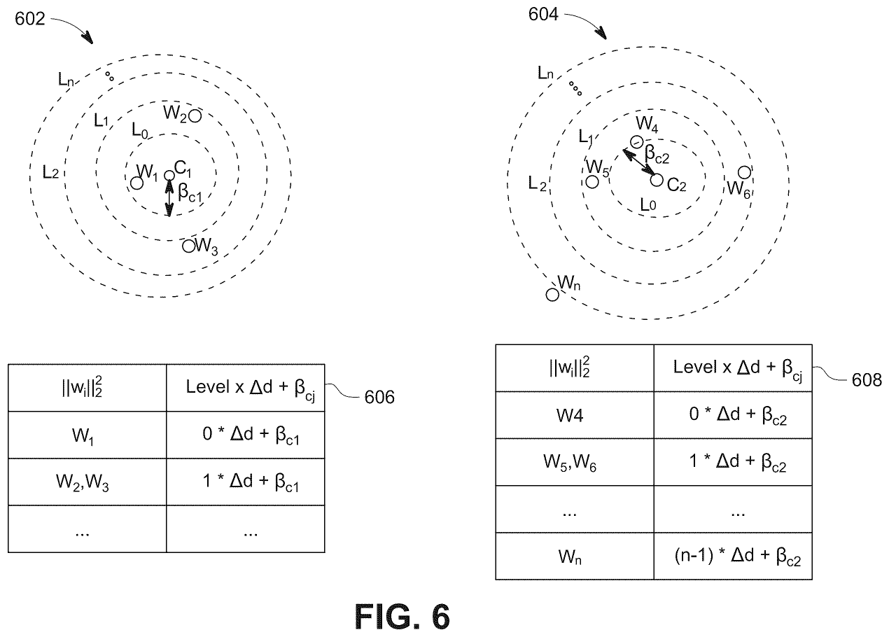

In some implementations, the second term ∥wᵢ∥² can be approximately determined based on a linear function. In some examples, the second term ∥wᵢ∥² can be determined based on the following linear function: levelₙ·Δd+β_{cj}. where levelₙ represent a level of the feature vector wᵢ within a cluster, Δd represents an interval between adjacent levels of the cluster, and β_{cj} represents a magnitude of the smallest level of the cluster. The approximation to the second term ∥wᵢ∥² will be discussed below with greater detail with reference to FIG. 6.

In some examples, the values of the term ∥wᵢ∥², representing the squared norm of feature vectors, can be precomputed and stored in a local storage, such as an internal memory or an external storage device. Precomputing these values helps reduce computational overhead during real-time (online) searches, as the norm values do not need to be recalculated repeatedly. During an online search operation, when a query vector is processed, the precomputed values of ∥wᵢ∥² can be retrieved from storage and transferred into memory. This approach improves efficiency by minimizing on-the-fly computations, ensuring faster data retrieval and enhanced system performance during search operations.

After the value of ∥x∥², the approximated value of ∥wᵢ∥², and the dot product x·wᵢ are obtained, the squared Euclidean distance can be approximately computed using the value of ∥x∥², the approximated value of ∥wᵢ∥², and the doc product x·wᵢ (308). In some examples, the squared Euclidean distance between the query vector x and the feature vector wᵢ can be derived by combining the value of ∥x∥², the approximated value of ∥wᵢ∥², and the dot product x·wᵢ according to the relation: ∥x−wᵢ∥²≈∥x∥²+∥wᵢ∥²−2x·wᵢ. This approximation can allow for efficient similarity-based searches, as it reduces the computational complexity typically involved in exact distance calculations. The resulting squared Euclidean distance provides a measure of dissimilarity, which can be used to determine how closely a given feature vector matches the query vector.

In some implementations, the similarity between the feature vector and the query vector is determined using dot product distance. The computation of dot product distance can include normalizing the query vector, feature vector, and centroid vector to a consistent scale, such as unit length. For example, in applications like nearest neighbor search or clustering, normalizing these vectors can ensure that similarity measurements are based on the direction of the vectors rather than their absolute magnitudes. This can improve the accuracy of similarity comparisons, particularly when dealing with high-dimensional data. In some implementations, normalization can be applied as a preprocessing step before computing the dot product, so that variations in vector magnitudes do not distort the similarity evaluation.

FIG. 4 is a flow chart illustrating an example method 400 for structuring search data, according to one or more implementations of the present disclosure. The method 400 can be performed by a memory device, e.g., the memory 116 of FIG. 1A, the memory device 170 of FIG. 1B, the addressable memory 190 of FIG. 1C, or the memory device 200 of FIG. 2, or the memory device and a controller, e.g., the host controller 122 of FIG. 1A, or the controller 160 of FIG. 1B, or the processing circuitry 182 and/or the communications circuitry 186 of FIG. 1C.

Feature vectors are obtained (402). In some implementations, a feature vector represents the attributes or characteristics of an object, entity, or input in numeric form. In some examples, a feature vector can include a set of numerical values, each corresponding to a specific feature or property of the object. For example, in a query-based search for a movie, a feature vector can encode attributes such as length, language, and genre as distinct numerical values, forming a structured, multi-dimensional representation that can be processed efficiently by a computing system.

Within a database, each feature vector can serve as a compact and standardized representation of an individual data entry. This structure can enable efficient computational operations, including searching, sorting, and matching. In a query-based search system, the database can store a plurality of feature vectors, with each vector uniquely representing a data item. The use of feature vectors transforms complex datasets into a structured format suitable for computational algorithms. By encoding each data entry as a feature vector, the system facilitates high-performance similarity searches by comparing the query vector with stored feature vectors to identify the most relevant matches.

The feature vectors are grouped into multiple clusters (404). In some implementations, each cluster contains a subset of the feature vectors from the database. In some implementations, clustering the feature vectors within a feature vector space involves various methods, with each cluster being linked to a centroid that represents and characterizes the cluster.

In some implementations, a clustering method includes iterative partitioning, where a predefined number of clusters is initialized, and feature vectors are assigned to the nearest clusters based on a selected distance metric, such as Euclidean distance. The centroids are updated by computing the mean of the feature vectors within each cluster, and the process is repeated until the centroids stabilize or meet a specified stopping criterion.

In some implementations, a clustering method includes hierarchical clustering, where clusters are formed through either an agglomerative approach, which starts with individual feature vectors and merges them into larger clusters, or a divisive approach, which begins with a single large cluster and recursively splits it into smaller ones. The centroids of the resulting clusters are computed by determining the mean or median of the feature vectors in each cluster.

In some implementations, a clustering method includes density-based clustering, where clusters are defined as regions of high feature vector density separated by regions of lower density. This approach can allow the formation of clusters with irregular shapes and varying sizes. The centroids for these clusters can be computed by averaging the feature vectors within each high-density region.

In some implementations, a clustering method includes probabilistic modeling, where clusters are represented by Gaussian distributions. The parameters of the distributions, such as the mean and variance, are estimated, and feature vectors are assigned to the clusters based on their likelihood of belonging to each distribution. The centroid of each cluster corresponds to the mean vector of the respective Gaussian distribution.

In some implementations, a clustering method includes constructing a nearest-neighbor graph, where feature vectors are connected to their closest neighbors, and clusters are formed by identifying densely connected subgraphs. The centroids of the clusters are determined by averaging the feature vectors within each identified subgraph.

These clustering methods can provide efficient organization of feature vectors by associating each cluster with a centroid. During query processing, the nearest centroids are first identified, and further computations are limited to feature vectors within the selected clusters. This approach can reduce computational complexity and improves the performance of search and retrieval tasks in large-scale feature vector spaces.

In each cluster, multiple levels of radius in each cluster are trained (406). In some implementations, these levels of radius represent different proximity thresholds for partitioning the cluster into distinct layers based on the distance from the centroid. By organizing feature vectors into levels according to their distances from the centroid, it can facilitate more efficient searches by narrowing down the search space incrementally. This approach can reduce unnecessary computations by focusing on feature vectors within relevant distance levels, thereby improving overall search performance and computational efficiency.

Clustering and training of feature vectors across multiple clusters can be carried out using the example method described below, with reference to FIG. 5. FIG. 5 is a diagram illustrating an example method for clustering feature vectors, according to one or more implementations of the present disclosure. The method can be performed by a memory device, e.g., the memory 116 of FIG. 1A, the memory device 170 of FIG. 1B, the addressable memory 190 of FIG. 1C, or the memory device 200 of FIG. 2, or the memory device and a controller, e.g., the host controller 122 of FIG. 1A, or the controller 160 of FIG. 1B, or the processing circuitry 182 and/or the communications circuitry 186 of FIG. 1C. In some implementations, an MAC operation can be executed using a device such as the memory 116 of FIG. 1A, the memory device 170 of FIG. 1B, the addressable memory 190 of FIG. 1C, or the memory device 200 of FIG. 2. In some implementations, operations like adding/minus/linear multiple operation in L2 distance (e.g., |a−b|²=|a|²+|b|²−2*<a, b>), comparison, and/or sorting can be executed using a device such as the host controller 112 of FIG. 1A, the controller 160 of FIG. 1B, or the processing circuitry 182 and/or the communications circuitry 186 of FIG. 1C.

Referring to FIG. 5, in a feature vector space 500, a plurality of feature vectors, denoted as the feature vectors w₁, w₂, . . . , wᵢ, are distributed such that the feature vector space 500 can be structured as a space including a plurality of levels, denoted L₀, L₁, L₂, . . . , Lₙ. Each level corresponds to a spherical surface centered at the origin denoted as C₀, where the spherical surface is characterized by a specific radius. The radius of each spherical surface defines the boundary of that level, thereby partitioning the feature vector space 500 into distinct regions. As a result, the feature vector space 500 includes a plurality of concentric spherical regions, each representing a distinct level. Each level represents a set of feature vectors whose magnitudes fall within a particular range, where the magnitude can be defined by the distance of a feature vector from the origin C₀.

The process of determining the radii of the spherical surfaces, and thus defining the levels, can be done through a training method by analyzing the distribution of feature vectors and identifying meaningful partitions. In some examples, the training method can begin by computing the magnitudes of the feature vectors and arranging them in ascending order based on their distance from the origin. This ordered set of magnitudes provides the basis for constructing the spherical surfaces that define the levels.

Once the initial set of magnitudes is obtained, the training method can employ clustering techniques or binning strategies to group feature vectors based on their magnitudes. Each group corresponds to a distinct level, and the radius of the spherical surface for that level is determined by analyzing the magnitudes of the feature vectors in the group. The radius can be selected based on various criteria, such as the maximum or average magnitude within the group, depending on the specific requirements.

In some examples, the radii of the spherical surfaces can be adjusted iteratively, to mitigate the variance of feature vectors within each level while maintaining the separation between adjacent levels. The adjustment can keep the feature vectors closely packed within a level and ensure that the boundaries between levels are well-defined. This iterative adjustment can continue until convergence is achieved, e.g., when subsequent iterations produce minimal changes in the radii of the spherical surfaces.

Upon completion of the training process, the radii of the spherical surfaces are finalized, and each feature vector can be assigned to a specific level based on its magnitude. In some examples, a feature vector is considered to belong to a particular level if its magnitude falls within the range defined by the corresponding spherical surface. The resulting partitioning of the feature vector space into levels can enable efficient organization and retrieval of feature vectors based on their relative magnitudes.

This approach can be utilized in systems that require efficient similarity searches, where the levels correspond to proximity thresholds for identifying nearest neighbors to a query feature vector. By structuring the feature vector space in this manner, the system can manage large sets of feature vectors while ensuring high precision in retrieval or categorization tasks.

In some implementations, the feature vectors are reprojected and reorganized into multiple clusters (e.g., cluster 1, cluster 2, cluster 3 in FIG. 5), with each cluster representing a distinct subset of the feature vector space 500, as if each cluster occupies a specific subspace of the overall vector space. Once the clusters are established, each cluster can independently define its own levels and corresponding spherical surfaces and origins (e.g., origin C₁, C₂, C₃). In some examples, the clustering process can involve multiple stages, including the initial grouping of feature vectors, the identification of spherical surfaces unique to each cluster, and the assignment of levels within each cluster.

In one example, the clustering process can begin with an analysis of the distribution of feature vectors across the feature vector space to identify natural groupings of feature vectors based on similarity criteria, such as spatial proximity or shared characteristics. Clustering algorithms, such as K-means, hierarchical clustering, or density-based methods, can be used to partition the feature vectors into multiple clusters. Each resulting cluster represents a group of feature vectors that are more closely related to one another than to those in other clusters.

Once the clusters are formed, the next step is to define levels within each cluster. In some examples, this can be done by examining the magnitudes of the feature vectors belonging to a particular cluster and constructing a series of concentric spherical surfaces centered around a designated point, such as the centroid of the cluster. The radius of each spherical surface is determined by analyzing the distances of feature vectors within the cluster from the centroid. Similar to the process for a single global feature vector space, clustering can involve determining radii based on criteria such as the maximum or average distance of feature vectors in a given group.

To ensure that the levels within a cluster are well-defined and meaningful, an adjustment process can be applied. This adjustment can involve mitigating intra-level variance while maintaining inter-level separation within the cluster. Additionally, the adjustment can include adjusting the separation between spherical surfaces in adjacent clusters to reduce overlap or interference between clusters. This can ensure that the feature vectors are clearly assigned to a specific cluster and level, improving the accuracy and efficiency of subsequent retrieval or classification tasks. In a cluster, inter-level distances (or intervals) between adjacent spherical surfaces can be identical or different from one another. For different clusters, inter-level distances (or intervals) between adjacent spherical surfaces in these clusters can be identical or different.

After the radii for the spherical surfaces in each cluster are determined, the levels within the cluster are finalized, and feature vectors are assigned accordingly. Each feature vector is associated with a level within its cluster based on its distance from the cluster centroid. The resulting structure can include multiple clusters, each with its own hierarchical organization of levels and spherical surfaces.

This clustering-based approach can offer several technical effects. It can enable finer-grained organization of the feature vector space by allowing distinct regions of the space to have their own independent levels. This can be useful in applications where feature vectors represent heterogeneous data with varying characteristics, such as embeddings from different classes or categories. By partitioning the feature vectors into clusters and defining levels within each cluster, the system can achieve more precise categorization and retrieval of feature vectors.

In some examples, the clustering process can be dynamic, allowing the system to adapt to changes in the feature vector space over time. New feature vectors can be incorporated by assigning them to existing clusters or by forming new clusters if necessary. The system can periodically update the cluster-specific levels and spherical surfaces to maintain optimal organization and retrieval performance.

This approach can be useful for applications involving large-scale feature vector datasets, such as image recognition, natural language processing, and recommendation systems, where efficient similarity search and categorization are desired. By leveraging cluster-specific levels and spherical surfaces, the system can improve both the accuracy and computational efficiency of its operations.

Referring back to FIG. 4, approximation to the squared vector length of the feature vectors is determined with respect to the multiple levels of each cluster (408). This approximation is computed to reduce the complexity and computational load associated with directly calculating the exact squared vector length during query processing. By precomputing and approximating these values relative to the levels within each cluster, the system can efficiently retrieve relevant feature vectors without performing costly real-time computations. This approach can improve both the speed and scalability of search operations, e.g., when dealing with large-scale datasets and high-dimensional feature vectors. Approximation to the squared vector length of the feature vectors is described below with reference to FIG. 6.

FIG. 6 illustrate an example method for computing an approximation to the squared vector length, according to one or more implementations of the present disclosure. The method can be performed by a memory device, e.g., the memory 116 of FIG. 1A, the memory device 170 of FIG. 1B, the addressable memory 190 of FIG. 1C, or the memory device 200 of FIG. 2, or the memory device and a controller, e.g., the host controller 122 of FIG. 1A, or the controller 160 of FIG. 1B, or the processing circuitry 182 and/or the communications circuitry 186 of FIG. 1C.

In FIG. 6, two vector spaces 602 and 604 are shown to demonstrate the computation of the approximation to the squared vector length. The vector spaces 602 and 604 can be examples of the vector spaces containing the clusters 1 and 2 in FIG. 5. As shown in FIG. 6, the vector space 602 contains a first cluster of feature vectors, including feature vectors w₁, w₂, and w₃, which are distributed across multiple concentric spherical regions centered at an origin denoted as C₁. Each spherical region corresponds to a respective level, forming levels L₀, L₂, L₂, . . . Lₙ. Similarly, the vector space 604 contains a second cluster of feature vectors, including feature vectors w₄, w₅, w₆, . . . , wₙ, which are distributed across multiple concentric spherical regions centered at an origin denoted as C₂, with corresponding levels L₀, L₂, L₂, . . . Lₙ.

In some implementations, the spherical surfaces, their radii, and thus the levels for each vector space are determined independently. For example, the radii of the spherical surfaces defining the levels of one vector space can be different from those of another vector space. This allows each vector space to have its own unique structure based on the distribution of feature vectors within that vector space.

In some implementations, the vector length of a feature vector is determined with respect to the origin of the vector space in which the feature vector resides. For example, in vector space 602, the vector lengths of the feature vectors w₁, w₂, and w₃ are determined relative to the origin C₁, while in vector space 604, the vector lengths of the feature vectors w₄, w₅, w₆, . . . , wₙ are determined relative to the origin C₂. In some implementations, the vector length of a feature vector is determined as a distance between the feature vector and a centroid vector of vector space or a cluster where the feature vector resides.

In some operations, the squared vector length of a feature vector is required for computing distances, such as the Euclidean distance, during query processing. However, directly calculating the squared vector length in real-time can impose a significant computational burden on the memory, e.g., when processing large datasets. To reduce this burden and improve computational efficiency, an approximation of the squared vector length can be used.

In some implementations, the squared vector length, denoted as ∥wᵢ∥² for a feature vector wᵢ, can be approximated using a linear function. In some examples, the squared vector length ∥wᵢ∥² can be approximated using the following linear function: levelₙ·Δd+β_{cj}. where levelₙ represent a level of the feature vector wᵢ within its vector space, Δd represents an interval between adjacent levels of the vector space, and β_{cj} represents a magnitude of the smallest level of the vector space. This linear approximation can reduce the computational complexity by precomputing certain terms offline, leaving lightweight operations for online query processing.

In some examples, the level of a feature vector can be determined based on its proximity to adjacent spherical surfaces. If a feature vector lies between two spherical surfaces, it can be assigned the level corresponding to the closer spherical surface. For example, in vector space 602, the feature vector w₁ is determined to be closer to the spherical surface corresponding to the level L₀, while the feature vectors w₂ and w₃ are closer to the spherical surface corresponding to the level L₁. Similarly, in the vector space 604, the feature vector w₄ is assigned to the level L₀, the feature vectors w₅ and w₆ are assigned to the level L₁, . . . , and the feature vector wₙ is assigned to the level Lₙ₋₁.

In some examples, the interval Δd represents a distance between two adjacent spherical surfaces, corresponding to adjacent levels within a vector space. The term β_{cj} represents a magnitude of the smallest level of vector space, which corresponds to the radius of the spherical surface at that level.

In some implementations, the values of Δd and β_{cj} are independently determined for each vector space, allowing them to vary across different vector spaces. For example, in FIG. 6, the vector spaces 602 and 604 have different values of β_{c1} and β_{c2}, representing the smallest levels of vector spaces 602 and 604, respectively. While the interval Δd is shown as being the same for vector spaces 602 and 604, in some cases it can differ between vector spaces depending on their specific configurations.

By adopting this approach, the computational burden on the memory can be reduced, and query processing performance can be improved. The approximation method can allow the system to efficiently approximate the squared vector lengths without performing expensive real-time computations, making it well-suited for large-scale applications involving high-dimensional feature vectors.

In some implementations, the values of squared vector length ∥wᵢ∥² for feature vectors are precomputed and stored in a look-up table. Each vector space or cluster is associated with a respective look-up table that stores these precomputed values. This precomputation allows the system to quickly retrieve the squared vector length during query processing, thereby reducing computational overhead and improving real-time performance.

For example, the look-up table 606 corresponds to the vector space 602, and the look-up table 608 corresponds to the vector space 604. During the online phase, when a query vector is processed, the system retrieves the squared vector lengths from the appropriate look-up table based on the cluster or vector space to which the feature vectors belong. By storing the squared vector lengths in this manner, the need for recalculating these values during each search operation is eliminated, enabling faster and more efficient distance computations.

In some cases, each entry in the look-up table may correspond to one or more specific feature vectors and contain the precomputed squared vector length associated with a particular level. For example, in the look-up table 606, the feature vector w₁ corresponds to a vector length associated with the level L₀, while the feature vectors w₂ and w₃ correspond to a vector length associated with the level L₁.

The look-up tables are organized to allow rapid indexing and retrieval, reducing latency during large-scale search operations. This approach can be useful when handling high-dimensional data, as it reduces both computation time and memory bandwidth requirements during the search process.

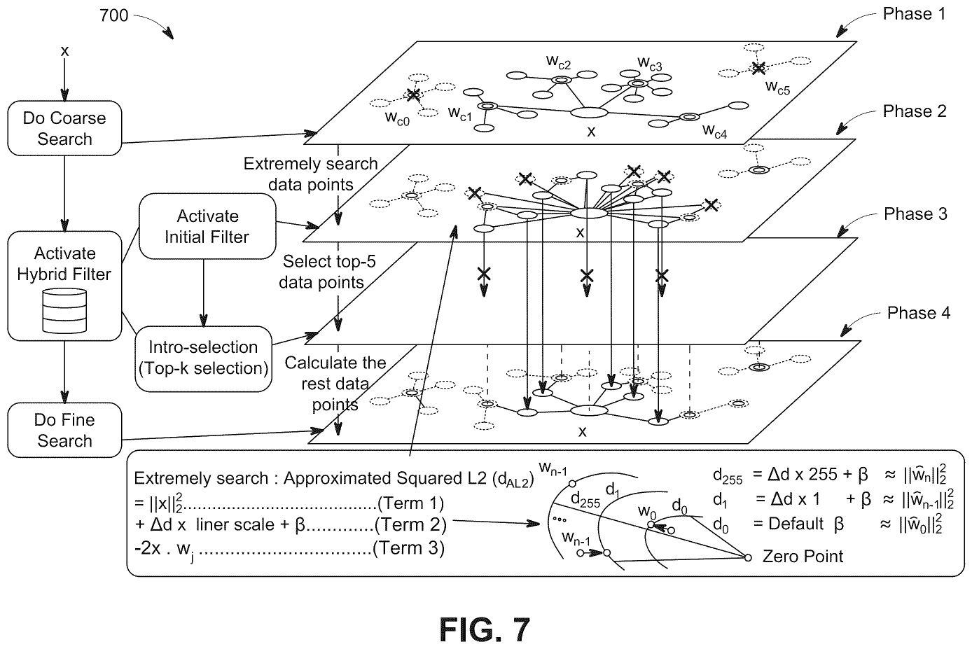

FIG. 7 illustrates an example search method 700, according to one or more implementations of the present disclosure. The method 700 can involve identifying the feature vector in a database that is most similar to a query vector provided in a request. The request specifies a query vector and initiates a search to find the closest match among feature vectors stored in the database. In some examples, the method 700 can be executed by one or more of the devices shown in FIGS. 1-3, including a memory device, e.g., the memory 116 of FIG. 1A, the memory device 170 of FIG. 1B, the addressable memory 190 of FIG. 1C, or the memory device 200 of FIG. 2, or the memory device and a controller, e.g., the host controller 122 of FIG. 1A, or the controller 160 of FIG. 1B, or the processing circuitry 182 and/or the communications circuitry 186 of FIG. 1C. The description of FIG. 7 can be understood in conjunction with the descriptions provided for the preceding figures, including FIGS. 1-6, to offer context and clarity regarding the components and processes involved.

Upon receiving a query vector, denoted as x in FIG. 7, the method 700 begins with a coarse search. In some implementations, the feature vectors in the database are grouped into a plurality of clusters, with each cluster associated with a representative centroid, such as a centroid vector or centroid point. Clustering is performed to reduce the search space, allowing the system to focus only on the most relevant subsets of feature vectors. As an example shown in FIG. 7, six clusters are present, each containing multiple feature vectors. The centroids of these clusters are denoted as w_{c0}, w_{c1}, w_{c2}, w_{c3}, w_{c4}, w_{c5}.

In the coarse search phase, distances between the query vector and the centroid vectors of the clusters are computed. Based on these distances, a subset of clusters with the short distances to the query vector is selected for further processing, e.g., a distance being smaller than a threshold. In some implementations, the top-n clusters (e.g., the top 256 clusters) with the short distances are selected. As illustrated in FIG. 7, during phase 1, the clusters with centroid vectors w_{c1}, w_{c2}, w_{c3}, w_{c4} are selected because they have the smaller distances to the query vector than the threshold. The clusters with the centroid vectors w_{c0}, w_{c5}, having larger distances than the threshold, are excluded from subsequent operations to reduce computational complexity.

After selecting the relevant clusters, a similarity between the query vector and each feature vector within the selected clusters is determined. In some implementations, this similarity is computed using an approximated Euclidean distance. The approximation method, as described with reference to FIGS. 3-6, involves determining the squared Euclidean distance by precomputing and storing certain terms during an offline phase and performing lightweight computations during the online phase. This approach can reduce the computational burden while maintaining high accuracy. Feature vectors with distances greater than a preset threshold are excluded from further processing. In phase 2 of FIG. 7, feature vectors that exceed the distance threshold in the selected clusters with centroids w_{c1}, w_{c2}, w_{c3}, w_{c4} are crossed out and removed from subsequent operations.

The remaining feature vectors, which have distances within the preset threshold, undergo further refinement. In some implementations, an intro-selection procedure is used to select the top-k feature vectors that best match the query vector. In some examples, intro-selection can be used for finding the top-k (e.g., top-5) smallest elements in an unsorted list, combining the properties of quicksort and heapsort to ensure optimal performance. In one example of intro-selection, a list of distances between a query vector and feature vectors can be obtained to select the 5 smallest distances. The intro-selection procedure partitions the list using quicksort logic to select a subset containing the smallest distances. Once the partitioning is complete, the top-5 smallest distances can be retrieved without fully sorting the entire list. In another example, a list of similarity scores between a query vector and feature vectors can be obtained to select the 10 highest scores. The subset of feature vectors with the highest similarity can be determined by partitioning the list and selecting the top-10 elements. This process can improve efficiency when compared to sorting the entire list. As shown in phase 3 of FIG. 7, feature vectors outside the top-5 are crossed out and removed from further operations.

In the final phase, a fine search is performed on the top-k feature vectors to identify the best match for the query vector. The fine search can involve a more precise computation of the similarity between the query vector and the remaining feature vectors. In some implementations, the fine search can involve computing the exact Euclidean distance or another high-precision similarity metric to determine the closest match. As illustrated in phase 4 of FIG. 7, the fine search processes the top-5 feature vectors selected in phase 3 to identify the feature vector that best matches the query vector. This final result is then returned as the best candidate.

By combining coarse and fine search phases, as well as employing clustering, distance approximation, and intro-selection, the method 700 can ensure efficient and accurate retrieval of the most relevant feature vector for the given query. This multi-stage approach can reduce computational complexity, minimize memory usage, and enhance performance, making it well-suited for large-scale datasets and real-time applications.

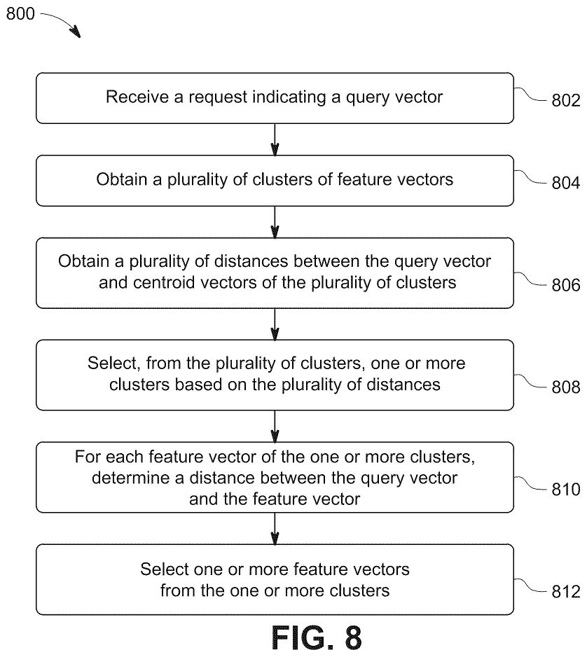

FIG. 8 illustrates an example method 800, according to one or more implementations of the present disclosure. In some examples, method 800 can be executed by one or more of the devices shown in FIGS. 1-3, including a memory device, e.g., the memory 116 of FIG. 1A, the memory device 170 of FIG. 1B, the addressable memory 190 of FIG. 1C, or the memory device 200 of FIG. 2, or the memory device and a controller, e.g., the host controller 122 of FIG. 1A, or the controller 160 of FIG. 1B, or the processing circuitry 182 and/or the communications circuitry 186 of FIG. 1C. The description of FIG. 8 can be understood in conjunction with the descriptions provided for the preceding figures, including FIGS. 1-7, to offer context and clarity regarding the components and processes involved.

A request indicating a query vector is received (802). In some implementations, the request specifies a query vector (e.g., query vector x in FIG. 7) and initiates a search to find the closest match among feature vectors (e.g., feature vectors w₁, w₂, . . . , wᵢ in FIG. 5) stored in a database. In some implementations, the query vector is a vector that represents the attributes of a user-provided query.

A plurality of clusters of feature vectors are obtained (804). In some implementations, feature vectors in the database can be grouped into clusters (e.g., clusters 1, 2, 3 in FIG. 5). Each cluster includes a subset of the feature vectors in the database, and each cluster can be associated with a centroid, such as a centroid vector or a centroid point (e.g., centroids C₁, C₂, C₃ in FIG. 5).

A plurality of distances between the query vector and centroid vectors of the plurality of clusters are obtained (806). In some implementations, the distance between the query vector and a centroid vector is determined using a distance metric, such as the Euclidean distance or an approximation thereof.

In some examples, the Euclidean distance is computed as the square root of the sum of squared differences between corresponding components of the query vector and the centroid vector. To reduce computational complexity, in some cases, an approximated squared Euclidean distance can be used, which eliminates the need to compute the square root. By applying this distance metric to each centroid vector, the system can identify the relative proximity of the query vector to each cluster, enabling efficient selection of relevant clusters for further processing.

One or more clusters are selected from the plurality of clusters based on the plurality of distances (808).

In some implementations, selecting, from the plurality of clusters, the one or more clusters based on the plurality of distances between the query vector and the centroid vectors of the plurality of clusters comprises: selecting, from the plurality of clusters, the one or more clusters associated with one or more centroid vectors that have one or more shortest distances to the query vector. For example, the system can apply a top-n selection, where n represents a predefined number of clusters to be selected. The clusters with the top-n shortest distances to the query vector are chosen for further processing. This selection approach can allow the system to focus on a limited number of relevant clusters, thereby improving search efficiency and reducing computational complexity.

For each feature vector of the one or more selected clusters, a distance between the query vector and the feature vector is determined (810). In some implementations, the distance between the query vector and the feature vector comprises a Euclidean distance. In some implementations, to improve computational efficiency, a squared Euclidean distance is used instead of Euclidean distance to avoid the need for expensive square root operations while still providing an accurate measure of similarity. In some implementations, an approximated squared Euclidean distance can be used, where certain terms are precomputed and stored during an offline phase. This approach can allow the system to efficiently compute distances during query processing by reducing the real-time computational burden. By using squared or approximated squared Euclidean distances, the system can handle large datasets and high-dimensional feature vectors more effectively, ensuring faster and more efficient search operations.

In some implementations, determining the distance between the query vector and the feature vector comprises performing the distance computation directly within the memory cell array, thereby reducing data movement and improving computational efficiency. In some examples, the dot product of the query vector and the feature vector can be computed directly in the memory cell array. The distance between the feature vector and the centroid vector and the distance between the query vector and the centroid vector can be obtained from a memory controller or another circuitry. This approach can leverage in-memory computing techniques, where the memory cell array itself can be used to execute operations such as vector multiplication and accumulation, reducing the need for transferring data to an external processor.

For example, after loading the query vector and the relevant feature vectors from the selected clusters into the memory cell array, the squared Euclidean distance between the query vector and each feature vector can be computed by performing element-wise operations and summing the squared differences within the memory cells. In some cases, parts of the computation, such as precomputed terms for the approximated squared Euclidean distance, may already reside in the memory, further reducing the workload.

In some implementations, determining the distance between the query vector and the feature vector includes: determining a distance (e.g., |lxii) between the feature vector and a centroid vector of a cluster to which the feature vector belongs; determining a distance (e.g., ∥wᵢ∥) between the query vector and the centroid vector of the cluster to which the feature vector belongs; determining a dot product (e.g., x·wᵢ) of the query vector and the feature vector; and determining the distance (e.g., ∥x−wᵢ∥) between the query vector and the feature vector based on the distance between the feature vector and the centroid vector, the distance between the query vector and the centroid vector, and the dot product. For example, the distance between the query vector and the feature vector can be determined using the following formula: d²∥x−wᵢ∥²=∥x∥²+∥wᵢ∥²−2x·wᵢ, where d² represents the squared Euclidean distance, x represents the query vector, wᵢ represents a feature vector.

In some implementations, determining the distance between the feature vector and the centroid vector of the cluster to which the feature vector belongs includes: determining the distance between the feature vector and the centroid vector of the cluster using a look-up table associated with the cluster. In such implementations, the look-up table (e.g., look-up tables 606, 608 in FIG. 6.) indicates a mapping relationship between: feature vectors of the cluster; and distances between the feature vectors and the centroid vector of the cluster.

In some implementations, determining the distance between the feature vector and the centroid vector of the cluster to which the feature vector belongs includes: determining a scale level (e.g., level L₀, L₁, . . . , or Lₙ in FIG. 5) of the feature vector in the cluster to which the feature vector belongs; determining a first value (e.g., Δd in FIG. 6) indicating an interval between adjacent scale levels of the cluster; and determining a second value (e.g., β_{c1} or β_{c2} in FIG. 6) indicating a magnitude of a smallest scale level of the cluster; and determining the distance between the feature vector and the centroid vector of the cluster based on the scale level of the feature vector, the first value, and the second value. In some examples, the squared vector length ∥wᵢ∥² can be used to indicate the distance between the feature vector and the centroid vector of the cluster to which the feature vector belongs. The squared vector length ∥wᵢ∥ ² can be determined based on the following linear function: levelₙ·Δd+β_{cj}. where levelₙ represent a level of the feature vector wᵢ within a cluster, Δd represents an interval between adjacent levels of the cluster, and β_{cj} represents a magnitude of the smallest level of the cluster.

In some implementations, determining the scale level of the feature vector in the cluster to which the feature vector belongs includes: determining the scale level of the feature vector in the cluster based on closeness of the feature vector to adjacent scale levels in the cluster. Each scale level corresponds to a spherical surface centered at the cluster's centroid, with specific radii defining the boundaries of the levels. The closeness of a feature vector to adjacent scale levels can be evaluated by measuring its distance from the corresponding spherical surfaces.

For example, if a feature vector is located between two adjacent spherical surfaces, the system can compare its distance to both surfaces and assigns it to the scale level corresponding to the closer surface. In some cases, if the feature vector is equidistant from two adjacent scale levels, a predefined rule may be applied to resolve the assignment, such as selecting the inner or outer level based on system parameters.

One or more feature vectors are selected from the one or more clusters based on distances between the query vector and feature vectors of the one or more clusters (812).

In some implementations, selecting the one or more feature vectors from the one or more clusters based on the distances between the query vector and the feature vectors of the one or more clusters includes: selecting a set of feature vectors from the one or more clusters based on a distance threshold, where a distance between each feature vector of the set of feature vectors and the query vector is less than the distance threshold; and selecting, from the set of feature vectors, the one or more feature vectors that have one or more shortest distances to the query vector.

For example, in a situation where the system initially selects a set of feature vectors from multiple clusters, each having a distance to the query vector below a predefined threshold. This filtering step reduces the number of feature vectors to be processed, improving computational efficiency by focusing only on the most relevant candidates. After filtering, the system can apply an intro-selection procedure to identify the top-k feature vectors with the shortest distances to the query vector. For example, if the top-5 closest feature vectors are required, the system selects the five feature vectors with the smallest distances from the filtered set. This two-step process can ensure that feature vectors within a reasonable proximity to the query vector are considered, followed by a fine-grained selection of the closest matches. By combining distance threshold filtering with top-k selection, the system can reduce unnecessary computations and enhance the precision of the search results.

The disclosed and other examples can be implemented as one or more computer program products, for example, one or more modules of computer program instructions encoded on a computer readable medium for execution by, or to control the operation of, data processing apparatus. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A system may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A semiconductor device comprising:
a memory cell array configured to store data in memory cells; and
a circuitry coupled to the memory cell array and configured to execute operations in the memory cell array, the operations comprising:
receiving a request indicating a query vector;
obtaining a plurality of clusters of feature vectors, wherein each cluster of the plurality of clusters is associated with a respective centroid vector;
determining a plurality of distances between the query vector and centroid vectors of the plurality of clusters;
selecting, from the plurality of clusters, one or more clusters based on the plurality of distances between the query vector and the centroid vectors of the plurality of clusters;
for each feature vector of the one or more clusters, determining a distance between the query vector and the feature vector; and
selecting one or more feature vectors from the one or more clusters based on distances between the query vector and feature vectors of the one or more clusters.

2. The semiconductor device of claim 1, wherein the distance between the query vector and the feature vector comprises a Euclidean distance.

3. The semiconductor device of claim 1, wherein determining the distance between the query vector and the feature vector comprises:
determining a distance between the feature vector and a centroid vector of a cluster to which the feature vector belongs;
determining a distance between the query vector and the centroid vector of the cluster to which the feature vector belongs;
determining a dot product of the query vector and the feature vector; and
determining the distance between the query vector and the feature vector based on the distance between the feature vector and the centroid vector, the distance between the query vector and the centroid vector, and the dot product.

4. The semiconductor device of claim 3, wherein determining the distance between the feature vector and the centroid vector of the cluster to which the feature vector belongs comprises:
determining the distance between the feature vector and the centroid vector of the cluster using a look-up table associated with the cluster, wherein the look-up table indicates a mapping relationship between:
feature vectors of the cluster; and
distances between the feature vectors and the centroid vector of the cluster.

5. The semiconductor device of claim 3, wherein determining the distance between the feature vector and the centroid vector of the cluster to which the feature vector belongs comprises:
determining a scale level of the feature vector in the cluster to which the feature vector belongs;
determining a first value indicating an interval between adjacent scale levels of the cluster;
determining a second value indicating a magnitude of a smallest scale level of the cluster; and
determining the distance between the feature vector and the centroid vector of the cluster based on the scale level of the feature vector, the first value, and the second value.

6. The semiconductor device of claim 5, wherein determining the scale level of the feature vector in the cluster to which the feature vector belongs comprises:
determining the scale level of the feature vector in the cluster based on closeness of the feature vector to adjacent scale levels in the cluster.

7. The semiconductor device of claim 1, wherein selecting the one or more feature vectors from the one or more clusters based on the distances between the query vector and the feature vectors of the one or more clusters comprises:
selecting a set of feature vectors from the one or more clusters based on a distance threshold, wherein a distance between each feature vector of the set of feature vectors and the query vector is less than the distance threshold; and
selecting, from the set of feature vectors, the one or more feature vectors that have one or more shortest distances to the query vector.

8. The semiconductor device of claim 1, wherein the selecting, from the plurality of clusters, the one or more clusters based on the plurality of distances between the query vector and the centroid vectors of the plurality of clusters comprises:
selecting, from the plurality of clusters, the one or more clusters associated with one or more centroid vectors that have one or more shortest distances to the query vector.

9. A system, comprising:
a semiconductor device; and
a controller coupled to the semiconductor device and configured to control the semiconductor device,
wherein the semiconductor device comprises:
a memory cell array configured to store data in memory cells; and
a circuitry coupled to the memory cell array and configured to execute operations in the memory cell array, the operations comprising:
receiving a request indicating a query vector from the controller;
obtaining a plurality of clusters of feature vectors, wherein each cluster of the plurality of clusters is associated with a respective centroid vector;
determining a plurality of distances between the query vector and centroid vectors of the plurality of clusters;
selecting, from the plurality of clusters, one or more clusters based on the plurality of distances between the query vector and the centroid vectors of the plurality of clusters;
for each feature vector of the one or more clusters, determining a distance between the query vector and the feature vector; and
selecting one or more feature vectors from the one or more clusters based on distances between the query vector and feature vectors of the one or more clusters.

10. The system of claim 9, wherein the distance between the query vector and the feature vector comprises a Euclidean distance.

11. The system of claim 9, wherein determining the distance between the query vector and the feature vector comprises:
determining a distance between the feature vector and a centroid vector of a cluster to which the feature vector belongs;
determining a distance between the query vector and the centroid vector of the cluster to which the feature vector belongs;
determining a dot product of the query vector and the feature vector; and
determining the distance between the query vector and the feature vector based on the distance between the feature vector and the centroid vector, the distance between the query vector and the centroid vector, and the dot product.

12. The system of claim 11, wherein determining the distance between the feature vector and the centroid vector of the cluster to which the feature vector belongs comprises:
determining the distance between the feature vector and the centroid vector of the cluster using a look-up table associated with the cluster, wherein the look-up table indicates a mapping relationship between:
feature vectors of the cluster; and
distances between the feature vectors and the centroid vector of the cluster.

13. The system of claim 11, wherein determining the distance between the feature vector and the centroid vector of the cluster to which the feature vector belongs comprises:
determining a scale level of the feature vector in the cluster to which the feature vector belongs;
determining a first value indicating an interval between adjacent scale levels of the cluster; and
determining a second value indicating a magnitude of a smallest scale level of the cluster; and
determining the distance between the feature vector and the centroid vector of the cluster based on the scale level of the feature vector, the first value, and the second value.

14. The system of claim 13, wherein determining the scale level of the feature vector in the cluster to which the feature vector belongs comprises:
determining the scale level of the feature vector in the cluster based on closeness of the feature vector to adjacent scale levels in the cluster.

15. The system of claim 9, wherein selecting the one or more feature vectors from the one or more clusters based on the distances between the query vector and the feature vectors of the one or more clusters comprises:
selecting a set of feature vectors from the one or more clusters based on a distance threshold, wherein a distance between each feature vector of the set of feature vectors and the query vector is less than the distance threshold; and
selecting, from the set of feature vectors, the one or more feature vectors that have one or more shortest distances to the query vector.

16. The system of claim 9, wherein the selecting, from the plurality of clusters, the one or more clusters based on the plurality of distances between the query vector and the centroid vectors of the plurality of clusters comprises:
selecting, from the plurality of clusters, the one or more clusters associated with one or more centroid vectors that have one or more shortest distances to the query vector.

17. A method comprising:
receiving a request indicating a query vector;
obtaining a plurality of clusters of feature vectors, wherein each cluster of the plurality of clusters is associated with a respective centroid vector;
determining a plurality of distances between the query vector and centroid vectors of the plurality of clusters;
selecting, from the plurality of clusters, one or more clusters based on the plurality of distances between the query vector and the centroid vectors of the plurality of clusters;
for each feature vector of the one or more clusters, determining a distance between the query vector and the feature vector; and
selecting one or more feature vectors from the one or more clusters based on distances between the query vector and feature vectors of the one or more clusters.

18. The method of claim 17, wherein the distance between the query vector and the feature vector comprises a Euclidean distance.

19. The method of claim 17, wherein determining the distance between the query vector and the feature vector comprises:
determining a distance between the feature vector and a centroid vector of a cluster to which the feature vector belongs;
determining a distance between the query vector and the centroid vector of the cluster to which the feature vector belongs;
determining a dot product of the query vector and the feature vector; and
determining the distance between the query vector and the feature vector based on the distance between the feature vector and the centroid vector, the distance between the query vector and the centroid vector, and the dot product.

20. The method of claim 19, wherein determining the distance between the feature vector and the centroid vector of the cluster to which the feature vector belongs comprises:
determining the distance between the feature vector and the centroid vector of the cluster using a look-up table associated with the cluster, wherein the look-up table indicates a mapping relationship between:
feature vectors of the cluster; and
distances between the feature vectors and the centroid vector of the cluster.
